(19) United States
(12) Patent Application Publication
(10) Pub. No.: US 2002/0177503 A1
(43) Pub. Date: Nov. 28, 2002

(54) Isolated planet gear

(76) Inventor: Robert Edward Beyerlein, Saginaw, MI (US)

Correspondence Address: EDMUND P. ANDERSON, DELPHI TECHNOLOGIES, INC., Legal Staff, Mail Code: 480-414-420, P.O Box 5052, Troy, MI, 48007-5052, US

(21) Appl. No.: 09/864,014

(22) Filed: May 23, 2001

(51) Int. Cl. F16H 55/14

(52) U.S. Cl. 475/331

(57) ABSTRACT

A planet gear includes a toothed portion having an axial bore, a hub disposed within the axial bore such that a space is defined between the hub and the toothed portion, and a spring disposed in the space. A gear is quieter in operation through configuration such that the gear includes a toothed portion having an axial bore and a hub coaxially orientable within the axial bore, and a spring is positioned between the hub and the toothed portion providing retention and isolation of the toothed portion relative to the hub.

### TECHNICAL FIELD

This disclosure relates to planetary gear systems, and, more particularly, to a planet gear having an isolation element (metallic wave spring) that reduces energy (vibration and noise) propagation during the operation of a planetary gear system into which the planet gear is incorporated.

### BACKGROUND

Planetary gear systems typically comprise a plurality of drivable or idler gears (e.g., planet gears) engaged by a pinion (e.g., a sun gear and/or a ring gear). Because they share a single load between several meshes of gears, planetary gear systems are generally more compact than parallel shaft drives and offer significant space savings. Planetary gear systems do, however, produce audible noise, which may be a detractor in some applications.

The problem of audible noise is exacerbated as a result of two conditions that exist within known planetary gear systems. The first condition is a function of the material of fabrication of the gears. Typically, at least one of the gears is fabricated from metal. Metal gears provide a much less compliant impact of the surfaces of the gear teeth when the gears mesh during the operation of the system. Such a reduced compliant impact increases the amount of noise generated. The second condition is a function of the energy dissipated in the system. Elastomeric O-rings may be disposed between an inside surface of a bored planet gear tooth portion and an outside surface of a hub/bushing assembly to minimize the transfer of gear mesh energy (vibration) from the teeth of the gear to the hub and to isolate the vibration from the remainder of the system, thereby reducing audible noise. Conventional elastomeric O-rings, however, are sensitive to environmental factors such as temperature that causes thermoset and permanent loss of elasticity, oils and greases, all of which have a detrimental effect on elastomers. Furthermore, durability issues, such as wear and aging, are a concern with elastomers. Therefore, an isolator with a design that retains an effective spring rate to isolate gear mesh energy is needed that is cost effective, durable and is less prone to environmental effects.

### SUMMARY

A wave spring isolator for use with a planet gear in a planetary gear system is described herein. The wave spring isolator of the present disclosure is disposed between the structural components of the planet gear. The planet gear includes a toothed portion having an axial bore, a hub coaxially orientable within the axial bore such that a space is defined between the hub and the toothed portion, and a wave spring isolator disposed therebetween. The wave spring isolator is configured having a corrugated ring for isolating gear mesh energy. The configuration of the wave spring isolator, in conjunction with the architecture of the planet gear, provides for a radial spring rate and a radial damping ability that effectively minimizes the amount of gear mesh energy transferred to other elements of the planetary gear system.

### BRIEF DESCRIPTION OF THE DRAWINGS

FIG. 1 is a perspective partially cutaway view of a planetary gear system.

FIG. 2 is an elevation view of a face of a toothed portion of a planet gear.

FIG. 3 is a cross-sectional view of the toothed portion of the planet gear of FIG. 2 taken along line 3-3.

FIG. 4 is an elevation view of a face of a hub of a planet gear.

FIG. 5 is a cross-sectional view of the hub of the planet gear of FIG. 4 taken along section line 5-5.

FIG. 6 is a top view of a wave spring isolator.

FIG. 7 is an elevation view of a planet gear having a wave spring isolator disposed therein.

FIG. 8 is a cross-sectional view of the planet gear of FIG. 7 taken along line 8-8.

FIG. 9 is an enlarged view of circumscribed area 9-9 in FIG. 7.

FIG. 10 is a cross-sectional view of an alternative embodiment of a toothed portion of the planet gear shown in FIG. 3.

FIG. 11 is an elevation view of an alternative embodiment of a face of a hub shown in FIG. 4.

### DETAILED DESCRIPTION

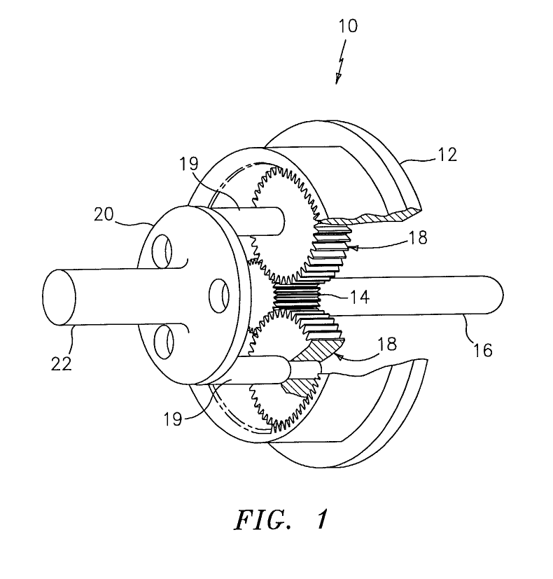

Referring to FIG. 1, a planetary gear system is shown generally at 10. Planetary gear system 10 reduces the speed of an input shaft and multiplies its torque. Applications in which planetary gear system 10 may be incorporated include, but are not limited to, various automotive steering and drive systems, aircraft and marine drive systems, and turbine engine reduction gear systems. In particular, planetary gear system 10 may be part of a rear electric steering mechanism for a motor vehicle.

Planetary gear system 10 comprises a ring gear 12, a sun gear 14 rotatably positioned within ring gear 12 and driven by an input shaft 16, and a plurality of planet gears, two of which are shown generally at 18. Planet gears 18 are configured to be in meshed engagement simultaneously with an outer toothed surface of sun gear 14 and an inner toothed surface of ring gear 12. Each planet gear 18 is axially and rotatably positioned on a dowel pin 19 mounted to a planet carrier 20. In one embodiment, each planet gear 18 rotates perimetrically about sun gear 14 and within ring gear 12 to simultaneously apply a load to planet carrier 20, which rotates to apply a torque to an output shaft 22 depending from planet carrier 20. In another embodiment (not shown), planet gears rotate on a planet carrier, which remains fixed relative to a sun gear, to apply a load to a ring gear. The ring gear then rotates to apply a torque to an output shaft (not shown) depending from the ring gear. Although planet gear 18 is applicable to either embodiment, only the configuration in which the output shaft depends from the planet carrier is described herein.

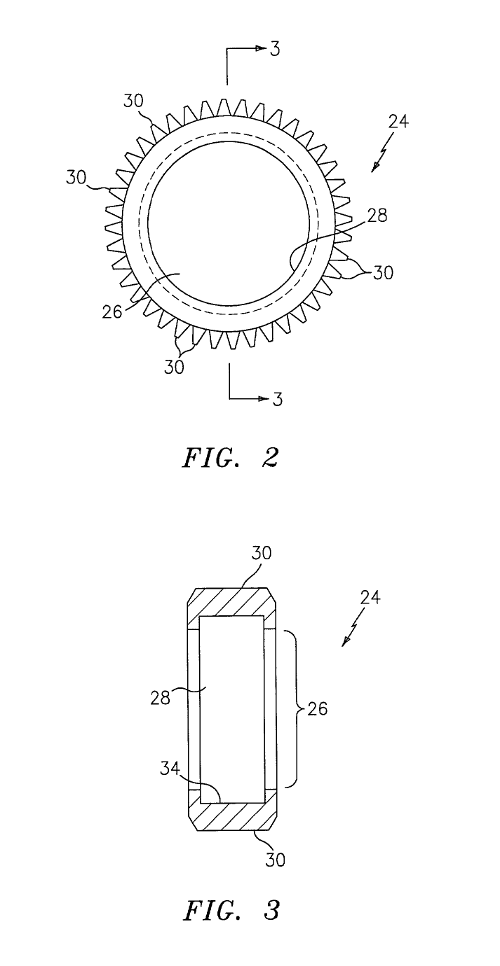

Planet gear 18 comprises a toothed portion, a hub, and a wave spring isolator disposed therebetween to provide isolation during the operation of planetary gear system 10 in which planet gear 18 is incorporated. Referring now to FIGS. 2 and 3, toothed portion, shown generally at 24, is illustrated in detail. Toothed portion 24 comprises an axial bore 26 defined by an inner surface 28 extending axially through the geometric center of toothed portion 24. Axial bore 26 optionally includes a bore that is neither necessarily cylindrical, nor a bore or hole that extends therethrough, (e.g., a partial cavity). A preferred embodiment includes an axial bore that is cylindrical, yet optionally includes any shape (e.g., triangular, square, etc.). Gear teeth 30 extend radially outwardly from an outer surface of the body of toothed portion 24. Teeth 30 are configured and dimensioned to engage the teeth of both the sun gear and the ring gear and to effectuate the movement of the planet carrier during operation of the planet gear system. A first continuous groove 34 is optionally formed circumferentially within inner surface 28 and extends around inner surface 28. A ridge or a plurality of holes (not shown) is optionally included instead of the groove 34 circumferentially within inner surface 28 extending around inner surface 28.

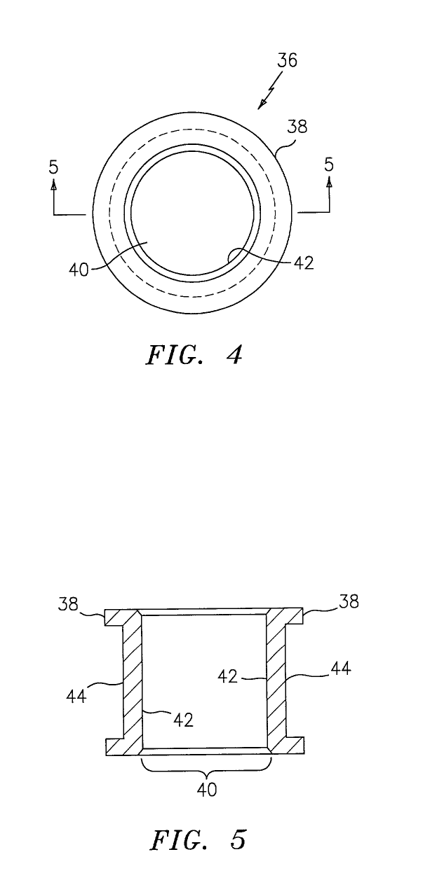

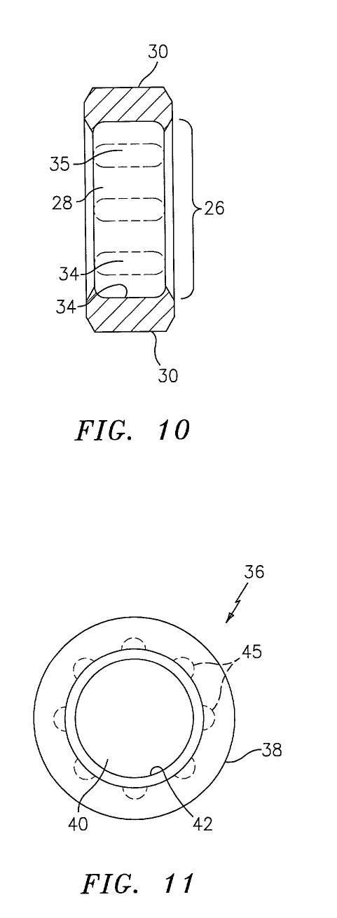

Hub 36 preferably comprises a substantially cylindrical element having a peripheral surface 38 and a bore 40 defined by an inner surface 42 extending axially therethrough (see FIGS. 4 and 5). Hub 36 is not necessarily cylindrical, but is coaxially orientable within axial bore 26 of toothed portion 24 and may be any shape, as with axial bore 26. Bore 40 is preferably typically chamfered on at least one end in order to facilitate the rotatable mounting of the planet gear on the dowel pin on the planet carrier. Bore 40 is optionally defined by an inner surface 42 that extends only partially into the hub 36 and does not extend therethrough. The perimetrical dimensions of hub 36 are less than a diameter of the bore 26 extending through the geometric center of the toothed portion 24. A second continuous groove 44 is preferably formed circumferentially within peripheral surface 38 and extends completely around hub 36. FIGS. 10 and 11 illustrate alternative embodiments showing a plurality of ridges 45, depicted by phantom lines in FIG. 11 that are included instead of the groove 44 circumferentially disposed within peripheral surface 38 and extend around hub 36. FIG. 10 illustrates utilization of a plurality of 35 instead of groove 34. If a first continuous groove 34, ridge (phantom lines in FIG. 10) or holes 35 are utilized, a second continuous groove 44, ridge or holes 45 are preferably axially located to correspond and align with the axial location of the first continuous groove or other corresponding respective ridge or hole when hub 36 and toothed portion 24 are assembled.

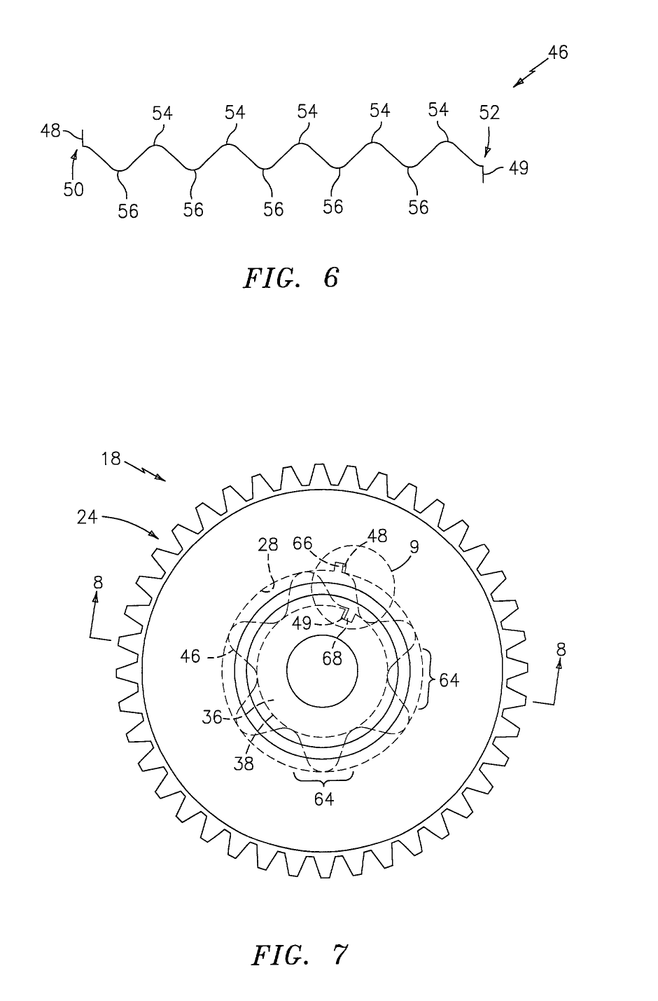

Referring now to FIG. 6, a preferred embodiment of a wave spring isolator 46 is illustrated. Wave spring isolator 46 is shown substantially rectangular in shape and corrugated having tabs 48, 49 extending from ends 50, 52 of the wave spring isolator 46. Wave spring isolator further comprises peaks 54 that define an upper amplitude of corrugation and valleys 56 that define a lower amplitude of corrugation. The peaks and valleys of corrugation are collectively referred to as folds 64 hereinafter. Wave spring isolator has one end 50 with one tab 48 extending from a peak 54 and another tab 49 extending from the opposite end 52 extending from a valley 56. Wave spring isolator 46 optionally includes any shape configured for use with hub 36 and toothed portion 24. The wave geometry and the material utilized in forming wave spring isolator 46 determine the stiffness of the spring when the isolator 46 is disposed between toothed portion 24 and hub 36. Furthermore, the amplitude of the corrugation is such that the peaks of corrugation are in contact with an exterior surface of groove 34 of toothed portion 24 and the valleys of the corrugation are in contact with an exterior surface of groove 44 of hub 36 when assembled in a planet gear. The wave spring isolator 46 provides both axial and torsional retention of the toothed portion on the hub. It will be noted that the preferred embodiment herein disclosed show that peaks and valleys are preloaded within the grooves 34, 44 and provide a substantial portion of the axial retention (provided by friction between the folds 64 and the grooves 34, 44) of the toothed portion 24 on the hub 36, thereby operably retaining the toothed portion 24 and the hub 36 together. The wave spring isolator 46 is assembled to the hub 36 and toothed portion 24, wherein the isolator 46 is captured within the groove 44 on hub 36 and compressed a predetermined amount (sufficient to avoid hub-to-toothed portion contact under expected load conditions) in the assembled state of the planet gear. The dimensions, as well as the stiffness rate of the wave spring isolator 46 are selected to provide for a clearance sufficient to allow radial excursion of the toothed portion 24 relative to the hub 36 while also avoiding hub-to-toothed portion contact under expected load conditions. The material used in manufacturing a wave spring isolator is preferably metallic that is optionally available in a variety in order to tune the stiffness and damping to meet the system requirements.

Referring now to FIGS. 7, 8 and 9, the assembled planet gear 18 is illustrated. The coaxial assembly of toothed portion 24 and hub 36 substantially defines an annulus between peripheral surface 38 of hub 36 and inner surface 28 of toothed portion 24 in which a wave spring isolator 46 is accommodated. The annulus is further defined by first and second grooves 34, 44, as can be seen in FIG. 8, which are each of a rectangular cross sectional shape or a similar geometry utilizing grooves 34, 44.

First and second grooves 34, 44 are dimensioned to provide a gap that is defined by a space between exterior surfaces of grooves 34, 44 that provide improved retention of hub 36 within toothed portion 24 when planet gear 18 is properly assembled and acts as a vibration propagation barrier for the planet gear. In particular, when a wave spring isolator is disposed within the annulus and held between retaining ridges 60 formed by grooves 34, 44 in hub 36 and toothed portion 24, hub 36 is secured in place within tooth portion 24 and is prevented from axial movement relative to tooth portion 24, as illustrated in FIG. 8. By selecting a material that has known resiliency and hardness, together with a predetermined number of folds 64 for the corrugation, the amount of force required to cause planet gear 18 to fail can be predetermined for a specific application.

Wave spring isolator 46 is disposed in the annulus formed by the coaxial assembly of hub 36 within toothed portion 24 to effectuate an isolation relationship between toothed portion 24 and hub 36. In a preferred embodiment, the annulus depicted in FIG. 8 is defined as having a rectangularly shaped cross section. Such a shape maximizes the surface area over which the folds 64 engage toothed portion 24 and hub 36, thereby enabling wave spring isolator 46 to provide improved axial retention of hub 36 within toothed portion 24. Such a configuration may provide for a portion of the torsional retention of hub 36 within toothed portion 24 by providing friction between peripheral surface 38 of hub 36 and the valleys 56 of folds 64 and between the peaks 54 of folds 64 and inner surface 28 of toothed portion 24, whereby the friction is greater when peripheral surface 38 of hub 36 and inner surface 28 are channeled, with configured slots (not shown) to encompass a greater surface area of folds 64.

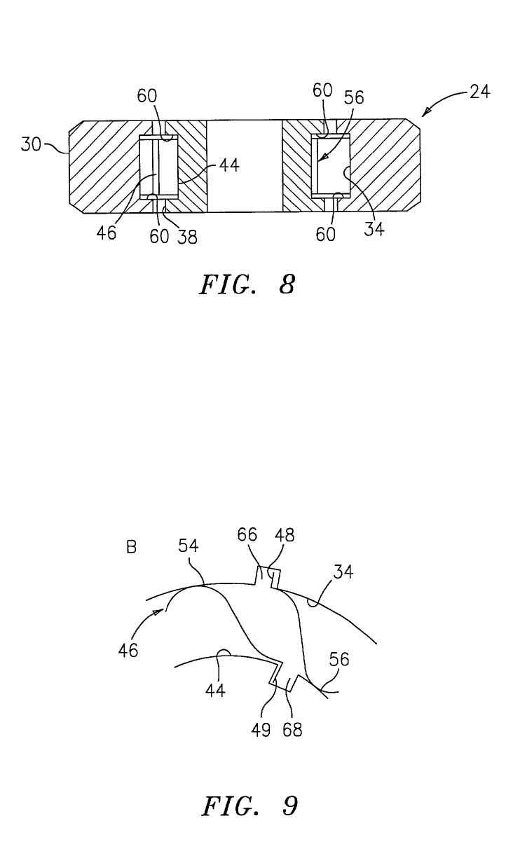

Referring now to FIGS. 7 and 9, a substantial portion of the torsional retention of hub 36 relative to toothed portion 24 is provided by tabs 48, 49 disposed in slots 66, 68. Slot 66 is disposed in groove 34 of toothed portion 24, wherein tab 48 is positioned in slot 66. Slot 68 is disposed in groove 44 of hub 36. Tabs 48, 49 positioned in slots 66,68 provide substantial torsional retention of the hub in relation to the toothed portion in either direction, and thereby effectively eliminating backlash between the hub and the toothed portion.

Metals used in the formation of wave spring isolator 46 include, but are not limited to, such as carbon, stainless steel, Inconel, and copper. The metal of choice is determined by the properties of the metal, the particular application, and the likelihood that the metal will withstand the environmental conditions that the planet gear into which the isolation element is incorporated is subjected to.

Utilization of metallic wave spring isolator offers a more durable, less environmentally sensitive, and additional freedom in design alternative to elastomer spring isolators. Elastomer spring isolators are more sensitive to environmental factors such as temperature causing thermoset, and oil and greases. A metallic wave spring isolator is also expected to be more durable as a metallic material is less susceptible to wear and aging. Moreover, a metallic wave spring has a linear spring rate over a large deflection compared to an elastomer spring, which in turn, offers greater dimensional freedom in design utilizing a metallic spring isolator.

Another benefit occasioned by the use of a single wave spring isolator in the space between the hub and the toothed portion is that in the event of a manufacturing oversight that results in the omission of the wave spring isolator, the condition is immediately discovered. Because the wave spring isolator provides support for the assembly of the hub within the toothed portion, the absence of the wave spring isolator causes the planet gear to fall apart. Such a condition is extremely noticeable during manufacturing procedures. By immediately discovering the absence of the wave spring isolator, the cause of the defective planet gear can be corrected, thereby preventing the release of an incomplete final product.

While preferred embodiments have been shown and described, various modifications and substitutions may be made thereto without departing from the spirit and scope of the invention. Accordingly, it should be understood that the present invention has been described by way of illustration only, and such illustrations and embodiments as have been disclosed herein are not to be construed as limiting to the claims.

What is claimed is:

1. A gear, comprising:
a toothed portion having an axial bore;
a hub disposed within said axial bore, said hub being positioned within said axial bore to define a space between said hub and said toothed portion; and
a spring disposed in said space to provide an isolation relationship between said toothed portion and said hub.

2. The gear of claim 1 wherein said spring comprises:
a corrugated ring having a number of folds defining said corrugation.

3. The gear of claim 2 wherein said spring further comprises:
a first tab and a second tab integrally depending from said corrugated ring, wherein said first tab is disposed in a first slot configured in said toothed portion and said second tab is disposed in a second slot configured in said hub.

4. The gear of claim 3 wherein said first tab is depending from one end of said corrugated ring and said second tab is depending from an opposite end of said corrugated ring.

5. The gear of claim 1 wherein said toothed portion includes a first groove circumferentially disposed in an inner surface thereof and wherein said hub includes a second groove circumferentially disposed in a peripheral surface thereof, said first groove and said second groove providing surfaces upon which said spring can set.

6. The gear of claim 5 wherein said corrugated ring has a width substantially as wide as said first groove and said second groove to prevent axial translation of said hub relative to said toothed portion.

7. The gear of claim 2 wherein said toothed portion includes a first plurality of configured slots circumferentially disposed in an inner surface thereof and wherein said hub includes a second plurality of configured slots aligned with said first plurality of configured slots circumferentially disposed in a peripheral surface thereof, said first plurality of configured slots and said second plurality of configured slots providing surfaces upon which said folds of said corrugated ring are retained.

8. The gear of claim 1 wherein said spring comprises a metallic material.

9. The gear of claim 7 wherein said metallic material is selected from the group consisting of carbon, stainless steel, Inconel, and copper.

10. The gear of claim 1 wherein said spring comprises a carbon material.
